(19) United States
(12) Patent Application Publication
(10) Pub. No.: US 2015/0029114 A1
(43) Pub. Date: Jan. 29, 2015

(54) ELECTRONIC DEVICE AND HUMAN-COMPUTER INTERACTION METHOD FOR SAME

(71) Applicant: HON HAI PRECISION INDUSTRY CO., LTD., New Taipei (TW)

(72) Inventor: HUA-WEI WU, New Taipei (TW)

(21) Appl. No.: 14/337,481

(22) Filed: Jul. 22, 2014

(30) Foreign Application Priority Data
Jul. 23, 2013 (TW) 102126208

(51) Int. Cl. G06F 3/0488

(52) U.S. Cl. CPC G06F 3/04886
USPC 345/173

(57) ABSTRACT

An electronic device includes a display member rotatably coupled to a base member. A touch-sensitive screen is located on a working surface of the base member. The touch-sensitive screen displays a virtual keyboard, and maps a first set of key values to the virtual keyboard based on a default language. A data receiving module receives data input by a user via the virtual keyboard. A human-computer interaction method is also disclosed.

### CROSS-REFERENCE TO RELATED APPLICATIONS

This application claims priority to Taiwan Patent Application No. 102126208 filed on Jul. 23, 2013 in the Taiwan Intellectual Property Office, the contents of which are hereby incorporated by reference.

### FIELD

The disclosure generally relates to electronic devices, and more particularly relates to electronic devices having a touch-sensitive screen and human-computer interaction methods.

### BACKGROUND

A portable computing device, such as a notebook computer, often includes a display member pivotally connected to a base member, and a physical keyboard located on the base member for receiving user input. However, such a physical keyboard is not user-friendly if a user needs to input content in multiple languages.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is an isometric view of an embodiment of an electronic device.

FIG. 2 is a block diagram of the electronic device of FIG. 1.

FIG. 3 is a block diagram of an embodiment of a human-computer interaction system.

FIG. 4 shows an embodiment of a virtual keyboard mapped with a set of key values based on English.

FIG. 5 shows an embodiment of a language selecting UI.

FIG. 6 shows an embodiment of a virtual keyboard mapped with a set of key values based on Japanese.

FIG. 7 is a flowchart of an embodiment of a human-computer interaction method.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

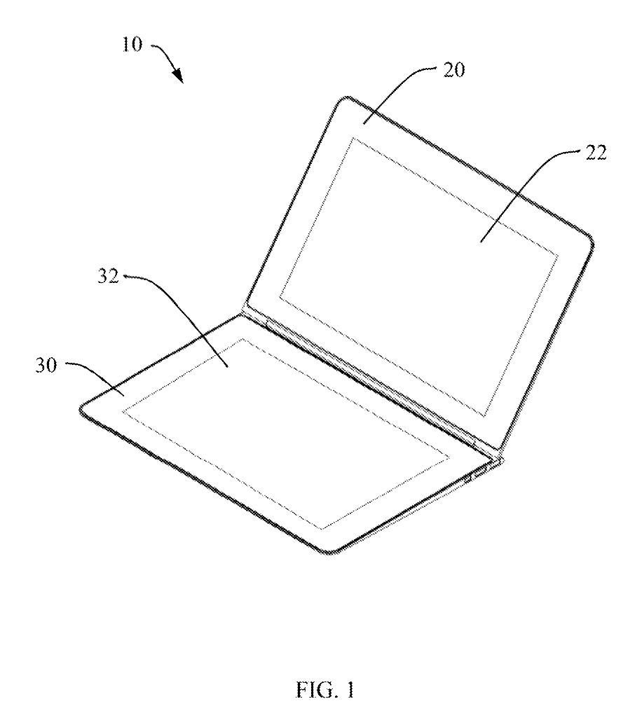

FIG. 1 illustrates an embodiment of an electronic device 10. The electronic device 10 can be, but is not limited to, a notebook computer, a tablet computer, a gaming device, a DVD player, a radio, a television, a personal digital assistant (PDA), a smart phone, or any other type of portable or non-portable electronic device.

The electronic device 10 includes a display member 20 pivotally connected to a base member 30, to enable variable positioning of the display member 10 relative to the base member 30. A display 22 is located on the display member 20. A touch-sensitive screen 32 is located on a working surface of the base member 30.

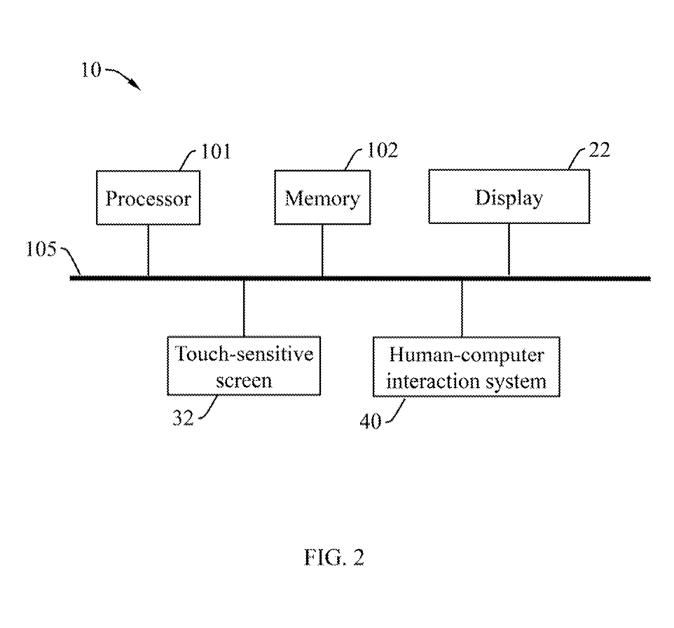

FIG. 2 illustrates a block diagram of an embodiment of the electronic device 10. The electronic device 10 includes at least one processor 101, a suitable amount of memory 102, a display 22, and a touch-sensitive screen 32. The electronic device 10 can include additional elements, components, and modules, and be functionally configured to support various features that are unrelated to the subject matter described here. In practice, the elements of the electronic device 10 can be coupled together via a bus or any suitable interconnection architecture 105.

The processor 101 can be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described herein.

The memory 102 can be realized as RAM memory, flash memory, EPROM memory, EEPROM memory, registers, a hard disk, a removable disk, a CD-ROM, or any other form of storage medium known in the art. The memory 102 is coupled to the processor 101, such that the processor 101 can read information from, and write information to, the memory 102. The memory 102 can be used to store computer-executable instructions. The computer-executable instructions, when read and executed by the processor 101, cause the electronic device 10 to perform certain tasks, operations, functions, and processes described in more detail herein.

The display 22 is suitably configured to enable the electronic device 10 to render and display various screens, GUIs, GUI control elements, menus, texts, or images, for example. The display 22 can also be utilized for the display of other information during operation of the electronic device 10, as is well understood.

The touch-sensitive screen 32 can display information, and detect and recognize touch gestures input by a user of the electronic device 10. The touch-sensitive screen 32 enables the user to interact directly with what is displayed thereon. The touch-sensitive screen 32 is suitable for two-hand operation by the user. In one embodiment, a length of the touch-sensitive screen 32 is greater than 18 centimeters. In other embodiments, the length of the touch-sensitive screen 32 is substantially the same as a length of the base member 30. In another embodiment, the touch-sensitive screen 32 includes a touch-sensitive surface made of carbon nanotubes.

A human-computer interaction system 40 can be implemented in the electronic device 10 using software, firmware, or other computer programming technologies.

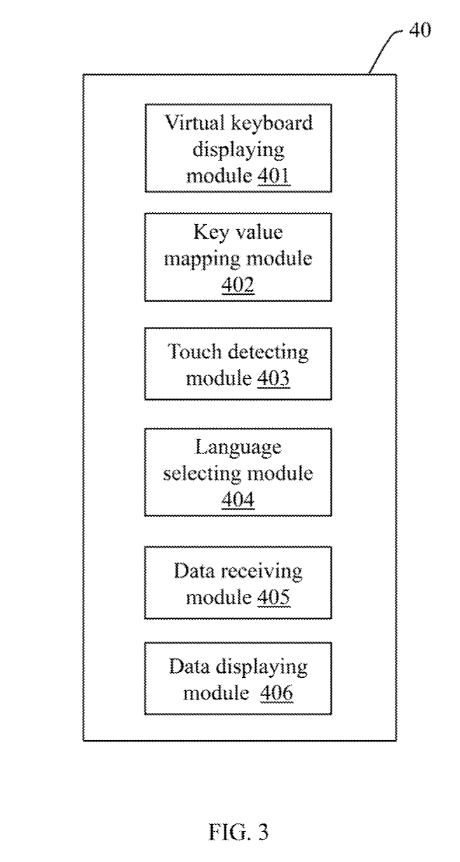

FIG. 3 illustrates an embodiment of a human-computer interaction system 40. The human-computer interaction system 40 includes a virtual keyboard displaying module 401, a key value mapping module 402, a touch detecting module 403, a language selecting module 404, a data receiving module 405, and a data displaying module 406.

The keyboard displaying module 401 can instruct the touch-sensitive screen 32 to display a virtual keyboard. The virtual keyboard includes a plurality of virtual keys.

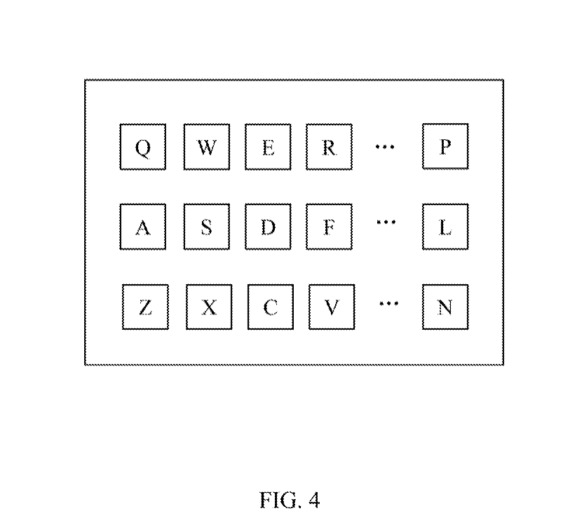

The key value mapping module 402 can map a set of key values to the virtual keyboard. The key value mapping module 402 associates each virtual key with a key value, and instructs the touch-sensitive screen 32 to display the key values on the corresponding virtual keys. FIG. 4 illustrates an embodiment of a virtual keyboard mapped with a set of key values based on English. As illustrated, a letter “Q” is mapped to a first virtual key from the left in a first line of the virtual keys of the virtual keyboard. The letter “Q” is displayed on the corresponding virtual key.

The touch detecting module 403 can detect touch gestures made with respect to the touch-sensitive screen 32.

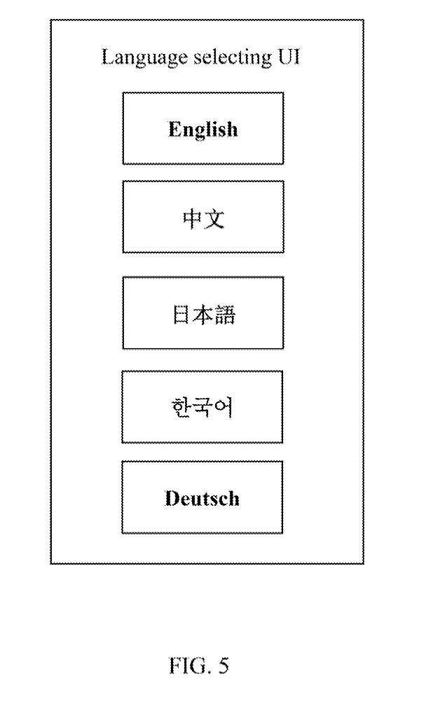

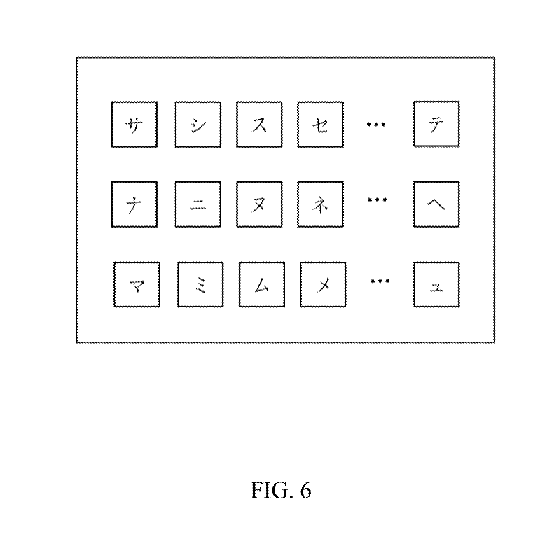

The language selecting module 404 can display a language selecting user interface (UI) on the touch-sensitive screen 32. FIG. 5 illustrates an embodiment of a language selecting UI. As illustrated, the language selecting UI can provide a list of supported languages such as English, Chinese, Japanese, Korean, and German. The user can select one of the supported languages via the language selecting UI. When a language is selected by the user, the key value mapping module 402 can map a corresponding set of key values to the virtual keyboard based on the selected language. FIG. 6 illustrates an embodiment of a virtual keyboard mapped with a set of key values based on Japanese. As illustrated, a Japanese letter “ [symbol] ” is mapped to a first virtual key from the left in a first line of the virtual keys of the virtual keyboard. The letter “ [symbol] ” is displayed on the corresponding virtual key.

The data receiving module 405 can receive data input by the user via the virtual keyboard.

The data displaying module 406 can display the received data on the display 22.

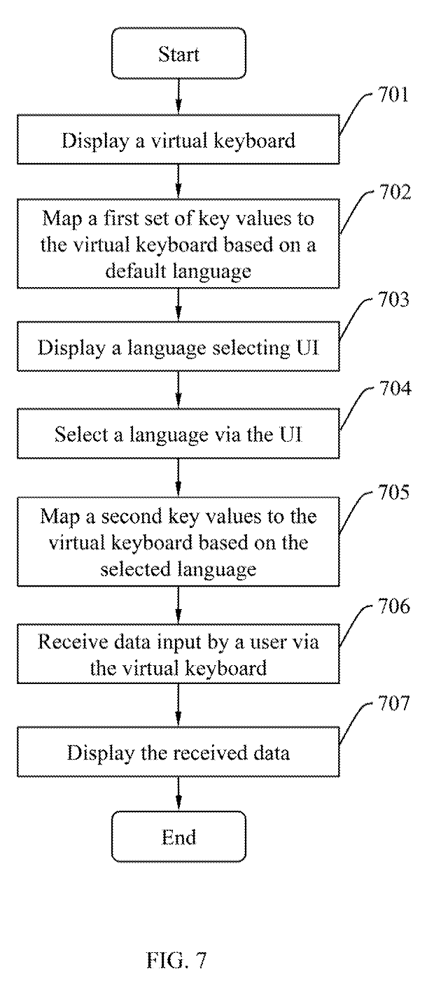

FIG. 7 illustrates a flowchart of one embodiment of a human-computer interaction method. The method includes the following steps.

In block 701, the keyboard displaying module 401 instructs the touch-sensitive screen 32 to display a virtual keyboard. The virtual keyboard includes a plurality of virtual keys.

In block 702, the key value mapping module 402 maps a first set of key values to the virtual keyboard based on a default language, e.g., English. The key value mapping module 402 instructs the touch-sensitive screen 32 to display the first set of key values on the corresponding virtual keys of the virtual keyboard.

In block 703, the language selecting module 404 displays a language selecting UI on the touch-sensitive screen 32.

In block 704, the language selecting module 404 selects a language according to a user selection via the language selecting UI.

In block 705, if the user selects a language that is not the default language, the key value mapping module 402 maps a second set of key values to the virtual keyboard based on the selected language. The key value mapping module 402 instructs the touch-sensitive screen 32 to display the second set of key values on the corresponding virtual keys of the virtual keyboard.

In block 706, the data receiving module 405 receives data input by the user via the virtual keyboard.

In block 707, the data displaying module 406 displays the received data on the display 22.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

Although numerous characteristics and advantages have been set forth in the foregoing description of embodiments, together with details of the structures and functions of the embodiments, the disclosure is illustrative only, and changes may be made in detail, including in the matters of arrangement of parts within the principles of the disclosure. The disclosed embodiments are illustrative only, and are not intended to limit the scope of the following claims.

What is claimed is:

1. An electronic device, comprising:
a base member;
a display member rotatably coupled to the base member;
a touch-sensitive screen located on a working surface of the base member, the touch-sensitive screen configured to display a virtual keyboard and map a first set of key values to the virtual keyboard based on a first language; and
a data receiving module configured to receive data input by a user via the virtual keyboard.

2. The electronic device of claim 1, wherein the display member comprises a display configured to display the data received by the data receiving module.

3. The electronic device of claim 1, wherein the touch-sensitive screen is further configured to display the first set of key values on the corresponding virtual keys of the virtual keyboard.

4. The electronic device of claim 1, wherein the touch-sensitive screen is further configured to generate a language selecting UI and map a second set of key values to the virtual keyboard based on a second language selected by a user via the language selecting UI.

5. The electronic device of claim 4, wherein the touch-sensitive screen is further configured to display the second set of key values on the corresponding virtual keys of the virtual keyboard.

6. The electronic device of claim 1, wherein the touch-sensitive screen is suitable for two-hand operation by the user.

7. The electronic device of claim 1, wherein a length of the touch-sensitive screen is substantially the same as a length of the base member.

8. The electronic device of claim 1, wherein the touch-sensitive screen comprises a touch-sensitive surface made of carbon nanotubes.

9. A human-computer interaction method implemented in an electronic device, the electronic device comprising a base member, a display member rotatably coupled to the base member, a touch-sensitive screen located on a working surface of the base member, the human-computer interaction method comprising, comprising:
displaying a virtual keyboard by the touch-sensitive screen;
mapping a first set of key values to the virtual keyboard based on a first language; and
receiving data input by a user via the virtual keyboard.

10. The human-computer interaction method of claim 9, wherein the display member comprising a display, the method further comprises displaying the data received by the data receiving module by the display.

11. The human-computer interaction method of claim 9, further comprising displaying the first set of key values on the corresponding virtual keys of the virtual keyboard.

12. The human-computer interaction method of claim 9, further comprising:
generating a language selecting UI by the touch-sensitive screen;
selecting a second language via the language selecting UI; and
mapping a second set of key values to the virtual keyboard based on a second language.

13. The human-computer interaction method of claim 12, further comprising displaying the second set of key values on the corresponding virtual keys of the virtual keyboard.

14. The human-computer interaction method of claim 9, wherein the touch-sensitive screen is suitable for two-hand operation by the user.

15. The human-computer interaction method of claim 9, wherein a length of the touch-sensitive screen is substantially the same as a length of the base member.

16. The human-computer interaction method of claim 9, wherein the touch-sensitive screen comprises a touch-sensitive surface made of carbon nanotubes.
